(19) United States
(12) Patent Application Publication
(10) Pub. No.: US 2012/0274101 A1
(43) Pub. Date: Nov. 1, 2012

(54) FENDER PROVIDING ENHANCED VISIBILITY

(76) Inventors: Rafal T. MYSLAK, Oswego, IL (US); Robert J. Madera, Lockport, IL (US)

(21) Appl. No.: 13/094,276

(22) Filed: Apr. 26, 2011

(51) Int. Cl. B62D 33/06; B62D 25/18

(52) U.S. Cl. 296/198; 296/190.01; 280/851

(57) ABSTRACT

A fender for a mobile machine having a traction device is disclosed. The fender may have a frame connectable to the mobile machine at an outer periphery of the traction device, and at least one slat joined to the frame and having a width extending a distance in a radial direction of the traction device. The at least one slat may be configured to block debris thrown by the traction device. An open space is formed by the frame and the at least one slat. The enclosed space provides a view of the outer periphery of the traction device from an operator's perspective onboard the mobile machine.

### TECHNICAL FIELD

The present disclosure relates generally to a fender and, more particularly, to a fender that provides for enhanced visibility of areas surrounding an associated machine.

### BACKGROUND

Machines such as wheel loaders, wheel dozers, motor graders, and wheeled excavators are each equipped with fenders that block mud and debris sprayed by the machine's wheels from contacting critical portions of the associated machine. Most machines are offered with a choice of only two fender sizes, including relatively smaller fenders that provide some degree of protection while allowing a portion of the corresponding wheel to be visible by the machine's operator, and larger fenders that provide greater protection but also block most, if not all, of the corresponding wheel from being viewed by the operator. Many machine operators observe the wheels to detect and limit wheel spin, thereby increasing life of the wheels. Accordingly, the machine's owner is forced to decide which is more important, machine protection or wheel visibility, and make a corresponding sacrifice when selecting the fender size.

One attempt to provide protection from wheel-generated mud and debris, while still allowing a machine operator to view an associated wheel is disclosed in U.S. Pat. No. 3,700,259 of Scheinkoenig et al. that issued on Oct. 24, 1972 (the '259 patent). In particular, the '259 patent discloses a fender for a rear wheel of a tractor. The fender has a vertical wall that is connected to a right angle flange, which extends peripherally around the wheel. A louver is formed within the vertical wall of the fender for viewing of wheel rotation by an operator of the tractor. The louver is located forward and downward of the operator.

Although the fender of the '259 patent may provide some protection from debris thrown into the air by a tractor's rear wheel and visibility of the wheel to the operator, it may lack broad applicability. In particular, the fender of the '259 patent may not be applicable to a front wheel, where the louver on the vertical wall of the fender would be obscured from the operator's view.

The disclosed fender is directed to overcoming one or more of the problems set forth above and/or other problems of the prior art.

### SUMMARY OF THE INVENTION

In one aspect, the present disclosure is directed to a fender for a mobile machine having a traction device. The fender may include a frame connectable to the mobile machine at an outer periphery of the traction device, and at least one slat joined to the frame and having a width extending a distance in a radial direction of the traction device. The at least one slat may be configured to block debris thrown by the traction device. An open space is formed by the frame and the at least one slat. The open space provides a view of the outer periphery of the traction device from an operator's perspective onboard the mobile machine.

In another aspect, the present disclosure is directed to another fender. This fender may include a generally box-like first frame having an open center, and a generally box-like second frame having a closed center and being connected at an obtuse interior angle to the first frame. The fender may also include a plurality of slats connected between opposing frame members of the first frame and having a width extending a distance in a height direction of the first frame. The plurality of slats are tilted in a length direction of the opposing frame members, and a plurality of open spaces are formed by the opposing frame members and the plurality of slats.

### BRIEF DESCRIPTION OF THE DRAWINGS

FIG. 1 is a pictorial illustration of an exemplary disclosed machine;

FIG. 2 is a diagrammatic illustration of an exemplary disclosed fender that may be used with the machine of FIG. 1;

FIG. 3 is a pictorial illustration of the fender of FIG. 2 during operation of the machine of FIG. 1; and

FIGS. 4-7 are pictorial illustrations of additional exemplary disclosed fenders that may be used with the machine of FIG. 1.

### DETAILED DESCRIPTION

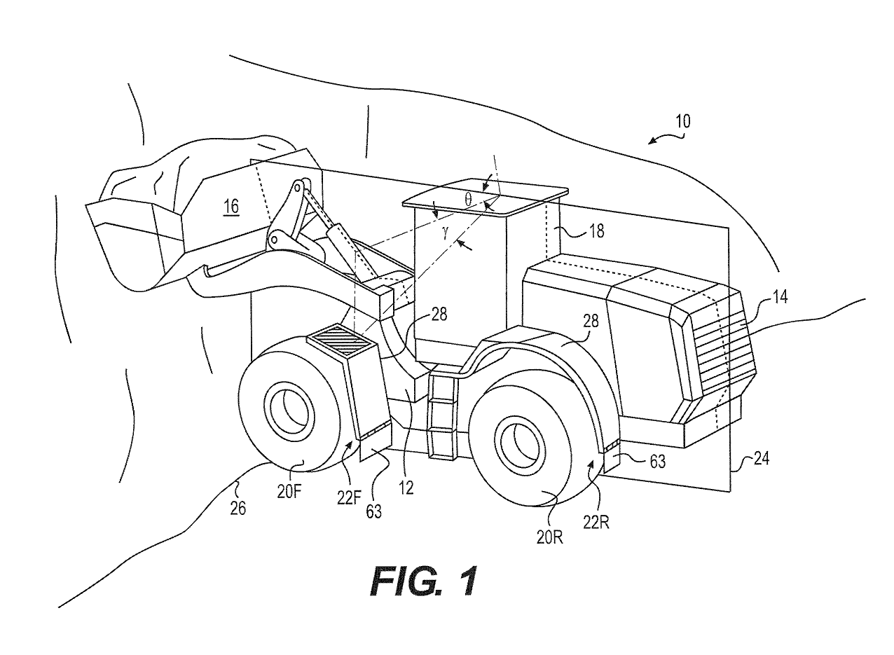

FIG. 1 illustrates an exemplary embodiment of a machine 10. Machine 10 may be a mobile machine that performs some type of operation associated with an industry such as mining, construction, farming, or another industry known in the art. For example, machine 10 may be an earth moving machine such as a wheel loader, a backhoe, a wheel dozer, or a motor grader. Machine 10, in one example, may include a machine frame 12 that supports a power source 14 at a back end, a work tool 16 at a front end, and an operator station 18 at a position about midway between power source 14 and work tool 16. Machine 10 may also include a plurality of traction devices 20 (including front traction devices 20F and rear traction devices 20R) that are rotatingly connected to machine frame 12 and driven by power source 14 to propel machine 10, and a plurality of fenders 22 (including front fenders 22F and rear fenders 22R) connectable to machine frame 12 (or another support structure of machine 10) and associated with traction devices 20.

Operator station 18 may be an onboard location from which the operator of machine 10 observes operations of and provides instructions for controlling machine 10. In the disclosed example, operator station 18 may be a substantially enclosed structure supported by frame 12 that includes one or more interface devices (not shown) located proximate an operator seat (not shown). It is contemplated, however, that operator station 18 may alternatively be a generally open platform, if desired, and may or may not include a seat (i.e., the operator may be required to stand during control of machine 10). From operator station 18, the operator of machine 10 may have a working view of tool 16 along a vertical plane 24 of general machine symmetry or primary motion, and a view of front traction devices 20F along vertical planes (not shown) that are oriented at an angle θ relative to plane 24. It is contemplated that θ may have a value of about +/−0-90° (i.e., 0-90° to the left for the front-left traction device 20F that is shown in FIG. 1, and 0-90° to the right for the front-right traction device 20F that is not shown). In the disclosed embodiment, θ has a value of about +/−60°. When viewing front traction devices 20F, in addition to looking to the left and right of plane 24, the operator may also be required to look downward (i.e., toward a ground surface 26) at an angle γ of about 0-65°. In the disclosed embodiment, γ has a value of about 45°.

Traction devices 20 may embody wheels located on each side of machine 10. In the depicted embodiment, two traction devices 20R are located toward a rear-end of machine 10 and arranged in left and right pairs, while two traction devices 20F are located toward a front-end of machine 10. Any of front and rear traction devices 20F, R may be driven and/or steered, as desired. It is also contemplated that one or all of traction devices 20 may be replaced with another type of traction device, if desired, such as tracks or belts.

Fenders 22 may function generally as guards associated with traction devices 20, to block mud and debris thrown into the air by traction devices 20 from contacting critical areas of machine 10 (e.g., operator station 18, power source 14, etc.). In the disclosed embodiment, two different styles and/or sizes of fenders 22 may be utilized, including front fenders 22F and rear fenders 22R corresponding to front and rear traction devices 20F, R, respectively. Each fender 22 may be connectable at a length-wise edge 28 to frame 12 (or another supports structure of machine 10) and cantilever away from machine 10 a distance about equal to an axial dimension of its corresponding traction device 20 (i.e., about equal to a width of traction device 20). Additional supports (not shown) may extend from frame 12 to distal portions of fenders 22, if desired. Each fender 22 may be configured to partially enclose its corresponding traction device 20, for example on at least an upper side (i.e., a side generally parallel with and opposite ground surface 26 relative to traction device 20) and an inner side (i.e., a side between traction device 20 and operator station 18). In some embodiments, fenders 22 may also partially enclose its corresponding traction device 20 on a third side. For example, rear fenders 22R shown in FIG. 1 partially enclose rear traction devices 20R on a side between traction device 20 and power source 14 or between traction device 20 and work tool 16.

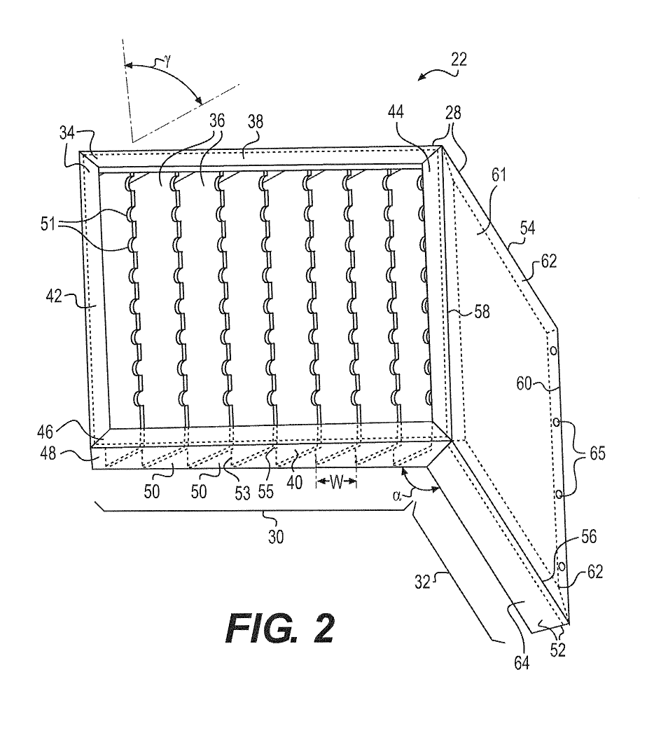

FIG. 2 shows an exemplary embodiment of front fender 22F. Front fender 22F may include a generally box-like first assembly 30 of components, and a generally box like second assembly 32. The components of each of assemblies 30, 32 may be welded, fastened, chemically bonded, or otherwise joined together in any manner known in the art. It is also contemplated that the components of assemblies 30, 32 may alternatively be integrally formed, for example through a casting, injection molding, or stamping process, as desired. In the exemplary embodiment of FIG. 2, the components of the individual assemblies 30, 32 are iron and joined together via welding, with assembly 30 then being welded or mechanically fastened to assembly 32.

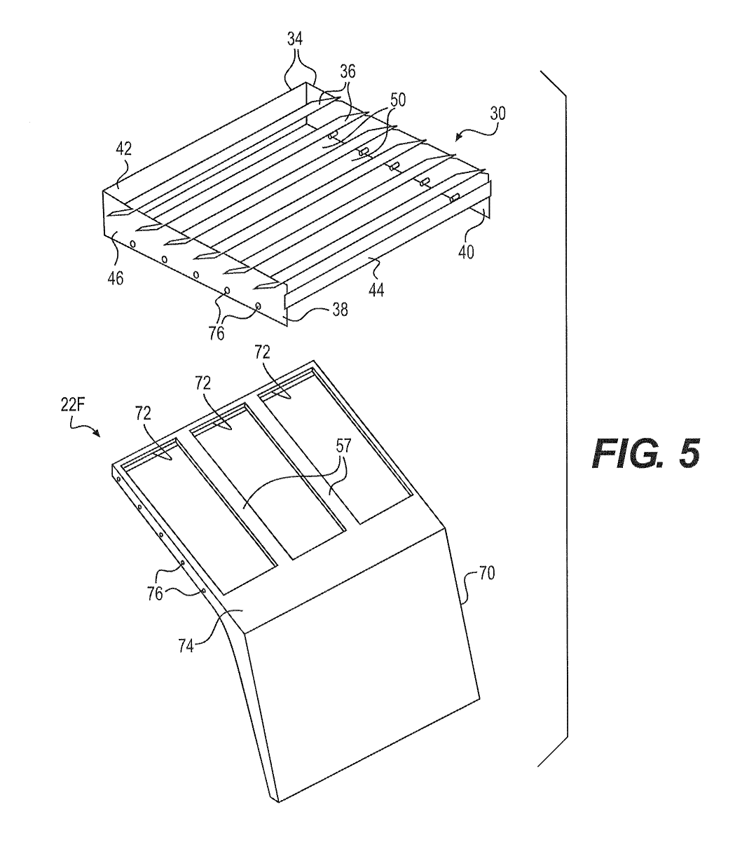

Assembly 30 may include, among other things, an outer frame 34 and a plurality of inner-located slats 36 connected to frame 34. Frame 34 may consist of opposing side frame members 38, 40 and opposing end frame members 42, 44. One of side frame members 38, 40 may be disposed between each pairing of aligned ends of end frame members 42, 44 to form the hollow box-shape of frame 34. In one embodiment, each of frame members 38-44 may include a generally horizontal surface 46, and a generally vertical surface 48 that is oriented substantially orthogonal to horizontal surface 46. When frame members 38-44 are joined together to form frame 34, horizontal surfaces 46 together may define a horizontal plane (i.e., a plane generally parallel to ground surface 26) and upper surface of front fender 22F. It is contemplated, however, that frame members 38-44 may alternatively only include a single surface (e.g., vertical surface 48, as shown in the embodiment of FIG. 5), if desired.

Inner slats 36 may be generally flat, and have a length direction, a width direction, and a thickness. Each slat 36 may extend in its length direction between side frame members 38, 40, and have a lengthwise edge 53 that is generally parallel with end frame members 42, 44. Ends of slats 36 may be positioned against vertical surfaces 48 of side frame members 38, 40 (or alternatively within slots formed within vertical surfaces 48, as shown in the embodiment of FIG. 5), such that an open space 50 defined by slats 36 and side frame members 38, 40 may be formed between each slat 36. In one embodiment, a horizontal width “W” of space 50 may be about equal to ½-⅓ of a width of slats 36. In the embodiment of FIG. 2, the width of slats 36 may be about equal to or greater than a width of vertical surfaces 48, and slats 36 may be tilted about an edge to an angle that corresponds with the viewing direction of the operator from operator station 18 (referring to FIG. 1). In particular, slats 36 may be tilted about lengthwise edge 53 toward end frame member 44 by an angle γ. In this manner, the operator of machine 10 may view through spaces 50 to see traction devices 20 and thereby discern the rotation of traction devices 20. In one embodiment, a lengthwise edge 55 of one slat 36, because of the tilt angle thereof, may overlap lengthwise edge 53 of the adjacent slat 36.

Although slats 36 are shown an have been described as generally parallel with each other and spaced apart from each other by a common spacing dimension, it is contemplated that slats 36 may be placed between side frame members 38, 40 in another manner if desired. For example, the spacing of slats 36 may be variable and change along a length direction of side members 38, 40, if desired. In another example, the shape (i.e., flatness) and/or orientation of slats 36 relative to each other may also or alternatively be variable. It should be noted that the spacing, shape, and/or orientation of slats 36 may be changed to block a desired amount of debris while providing a desired view for the operator.

It is contemplated that, in some embodiments, front fenders 20F may be utilized as standing platforms during service of machine 10. In these embodiments, slats 36 may be supported from below in one or more places along their mid-sections by additional frame supports (similar to supports shown only in FIG. 5) extending between end frame members 42, 44. These additional supports may also provide vibration dampening and reduce flexure of slats 36 caused by machine operation. Each slat 36 may also be provided on an upper surface thereof with features that improve traction for the service technician. These features may include, for example, serrations 51 cut into lengthwise edges 55 of slats 36, protrusions (not shown) added to slats 36, a roughened surface material (not shown) applied to slats 36, or other features known in the art.

Assembly 32, similar to assembly 30, may include an outer frame 52 consisting of side frame members 54, 56, end frame members 58, 60, and a plate 61 connected between frame members 54-60. One of side frame members 54, 56 may be disposed between each pairing of aligned ends of end frame members 58, 60 to form the solid box-shape of frame 52. In one embodiment, each of frame members 54-60 may include a generally horizontal surface 62 and a generally vertical surface 64 that is oriented substantially orthogonal to horizontal surface 62. When the components of frame 52 are joined together, plate 61 may define an inclined plane and rear surface of front fender 22F. In the disclosed embodiment, assembly 32 may be inclined relative to assembly 30 by an interior angle α of about 40-90°. It is contemplated that plate 61 may be replaced, in part or in whole, with slats 36, if desired, to enhance the operator's view of traction devices 20.

Assembly 32 may also be configured to provide a mounting surface for a mud flap 63 (shown only in FIG. 1), if desired. In particular, plate 61 and/or end frame member 60 may include features, for example holes 65, configured to receive fasteners (not shown) that connect mud flap 63 to assembly 32. Mud flap 63 may be generally flexible and made, for example, from a reinforced rubber or nylon material.

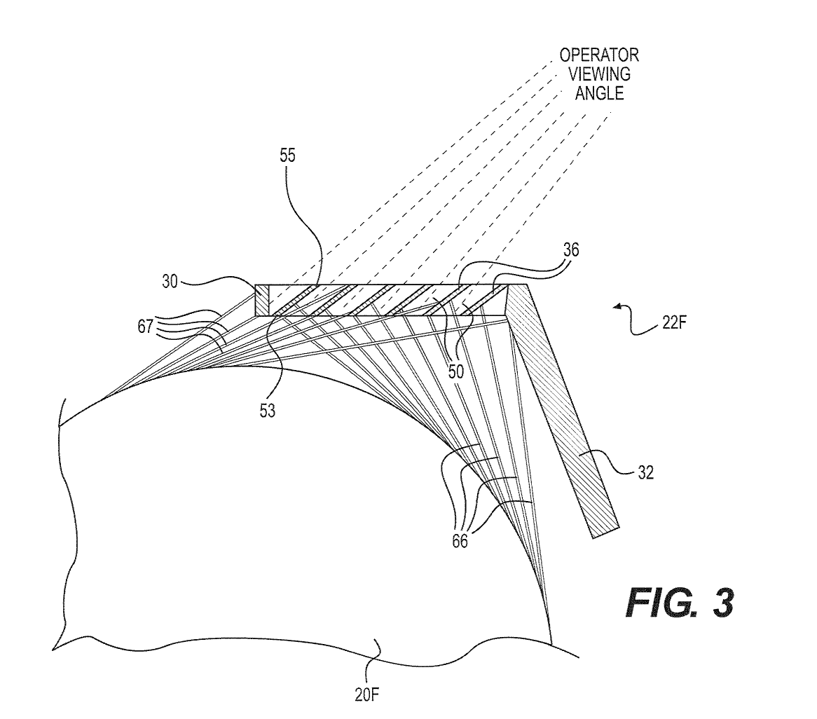

As shown in FIG. 3, the dimensions of slats 36 and spaces 50 may be selected to inhibit mud and debris thrown by front traction device 20F from passing beyond front fender 22F, while still allowing the operator of machine 10 to view front traction device 20F through front fender 22F. In particular, FIG. 3 shows trajectory lines 66, 67 of debris thrown into the air by front traction device 20F during forward and reverse travel, respectively. Trajectory lines 66 may be generally straight, arcuate, and/or parabolic, depending on traction device speed, and are shown as tangentially initiating from a periphery of traction devices 20F and contacting slats 36 in a generally orthogonal manner. When coupled with the width dimension of space 50 and the overlapping nature of adjacent slats 36, no clear path forward through front fender 22F may exist for the debris (i.e., slats 36 together may provide a solid blocking surface against the debris thrown during travel in the forward direction). Similarly, trajectory lines 67 are shown as impinging against leading surfaces of slats 36, with few, if any, clear paths rearward through front fender 22F.

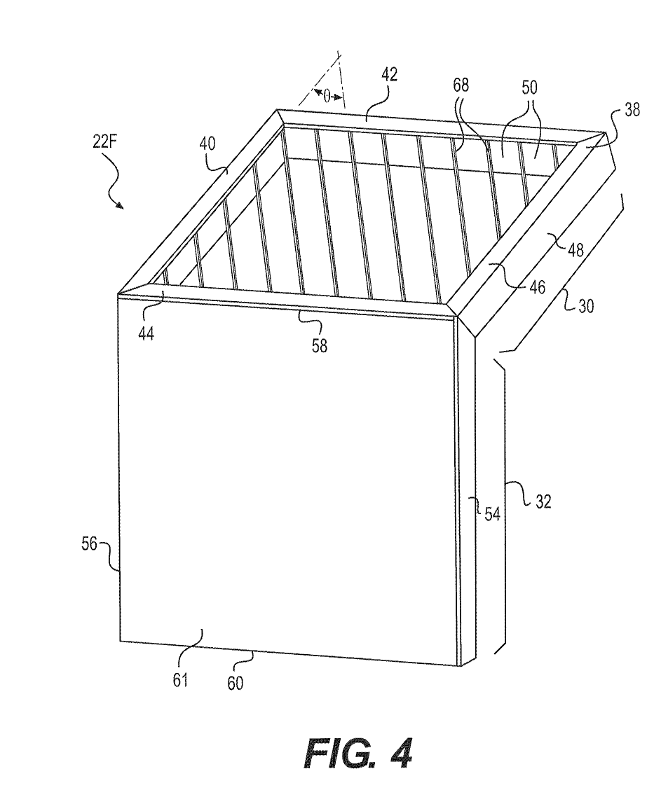

FIG. 4 illustrates an alternative embodiment of front fender 22F. Similar to the embodiment of FIG. 2, front fender 22F of FIG. 4 includes first and second assemblies 30, 32 connected to each other at an obtuse interior angle. In the embodiment of FIG. 4, second assembly 32 may be substantially identical to second assembly 32 of FIG. 2. However, in contrast to the embodiment of FIG. 2, slats 36 of first assembly 30 may be replaced with different slats 68 in the embodiment of FIG. 4. Slats 68 may have varying lengths and a width dimension about equal to or less than a width of vertical surface 48. In addition, slats 68 may be oriented without tilt in the vertical direction (i.e., without tilt about lengthwise edge 53). Instead, slats 68 may be rotated in a horizontal direction relative to plane 24 (referring to FIG. 1) to substantially match angle θ of the operator's perspective (i.e., the perspective corresponding with the point of view shown in FIG. 4). Although slats 68 may no longer be tilted in the vertical direction by angle γ, the horizontal rotation to angle θ may still allow for the operator to see front traction devices 20F through front fender 22F. As with the configuration of front fender 22F shown in FIG. 2, the height, spacing, and orientation of slats 68 shown in FIG. 4 may combine to substantially inhibit debris thrown by front traction devices 20F from passing through front fender 22F.

FIG. 5 illustrates another exemplary embodiment of front fender 22F. In this embodiment, the depicted front fender 22F may be the result of retrofitting an existing fender 70 such that the operator's view of front traction device 20F is enhanced. In this embodiment, the existing fender 70 has had multiple sections 72 (e.g., three sections 72) removed from an upper planar surface 74. Strips of upper planar surface 74 may be left intact between adjacent sections 72 to form supports 57 for slats 36. After removal of sections 72, assembly 30 may be placed over upper planar surface 74, and connected in place by passing fasteners (not shown) through holes 76 or via welding, as desired.

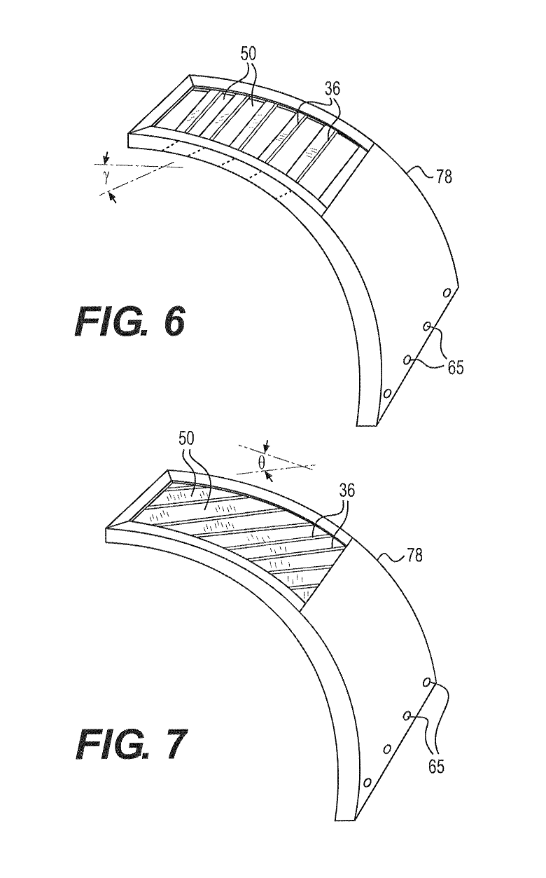

FIGS. 6 and 7 illustrate yet additional exemplary embodiments of front fender 22F. In these embodiments, front fender 22F may no longer be fabricated from two separate box-like frames 34, 52. Instead, front fender 22F of FIGS. 6 and 7 may include a generally arcuate frame 78 that has a curvature substantially concentric with a curvature of front traction device 20F, when assembled to machine 10. Front fender 22F of FIGS. 6 and 7 may include slats 36 and 68, respectively, that have been tilted by angle γ and/or rotated relative to plane 24 by angle θ, and that are positioned apart from each other by spaces 50 such that debris from traction devices 20 may be inhibited from passing through front fender 22F while still allowing the operator to view traction devices 20. It is contemplated that the segment position of slats 36 along the arc of frame 78 may be variable and based on, among other things, the particular configuration (i.e., length, height, wheel size, etc.) of machine 10.

### INDUSTRIAL APPLICABILITY

The disclosed fender may be applicable to any mobile machine where improved visibility of areas surrounding the machine is desired, without sacrificing protection from debris thrown into the air by associated traction devices. The disclosed fender may provide improved visibility of the traction devices, of machine work tools, of pedestrians passing by the machine, and other things near the machine by providing open spaces within an upper surface of the fender. The open spaces may be aligned with an operator's perspective from the operator station onboard the machine, and have geometry designed to block debris.

It will be apparent to those skilled in the art that various modifications and variations can be made to the disclosed fender without departing from the scope of the invention. Other embodiments of the fender will be apparent to those skilled in the art from consideration of the specification and practice of the fender disclosed herein. For example, although the disclosed fender has been described as primarily for use with front-located traction devices, it is contemplated that a similar fender that has been oriented approximately 180° front to back may be used for rear-located traction devices, if desired. In addition, although the disclosed fenders have been described as including multiple slats and associated spaces, it is also contemplated that the fender may have only a single slat and/or a single space, if desired. It is intended that the specification and examples be considered as exemplary only, with a true scope being indicated by the following claims and their equivalents.

What is claimed is:

1. A fender for a mobile machine having a traction device, comprising:
a frame connectable to the mobile machine at an outer periphery of the traction device;
at least one slat joined to the frame and having a width extending a distance in a radial direction of the traction device, the at least one slat configured to block debris thrown by the traction device,
wherein an open space is formed by the frame and the at least one slat, the open space providing a view of the outer periphery of the traction device from an operator's perspective onboard the mobile machine.

2. The fender of claim 1, wherein:
the frame includes opposing frame members that extend in a fender length direction; and
the at least one slat extends in a slat length direction between the opposing frame members.

3. The fender of claim 2, wherein the at least one slat extends in the slat length direction a distance about equal to an axial dimension of the traction device.

4. The fender of claim 2, wherein the at least one slat includes a plurality of slats oriented substantially parallel to each other.

5. The fender of claim 2, wherein;
the opposing frame members and the at least one slat together form a generally box-like first assembly;
the frame further includes a generally box-like second assembly; and
the first assembly is connected to the second assembly to partially enclose the traction device.

6. The fender of claim 5, wherein an interior angle between the first and second assemblies is about 40-90°.

7. The fender of claim 5, wherein the at least one slat is tilted about a lengthwise edge in the fender length direction of the opposing frame members.

8. The fender of claim 7, wherein the at least one slat is tilted about the lengthwise edge to an angle of about 0-65° relative to the fender length direction.

9. The fender of claim 5, wherein the at least one slat is generally perpendicular to the fender length direction of the opposing frame members.

10. The fender of claim 5, wherein the at least one slat is oriented diagonally between the opposing frame members.

11. The fender of claim 10, wherein an interior angle between the at least one slat and the opposing frame members is about 0-90°.

12. The fender of claim 1, wherein the frame has a curvature generally concentric with a curvature of the traction device.

13. A fender, comprising:
a generally box-like first frame having an open center;
a generally box-like second frame having a closed center and being connected at an obtuse interior angle to the first frame; and
a plurality of slats connected between opposing frame members of the first frame and having a width extending a distance in a width direction of the first frame,
wherein:
the plurality of slats are tilted about a lengthwise edge in a fender length direction of the opposing frame members and/or oriented diagonally between the opposing frame members of the first frame; and
a plurality of open spaces are formed by the opposing frame members and the plurality of slats.

14. A mobile machine, comprising:
a machine frame;
an operator station supported by the machine frame;
a front wheel connected to the machine frame;
a fender frame connected to the machine frame at an outer periphery of the front wheel;
a least one slat joined to the fender frame and having a width extending a distance in a radial direction of the front wheel, the at least one slat configured to block debris thrown by the front wheel,
wherein an open space is formed by the fender frame and the at least one slat, the open space providing a view of the outer periphery of the front wheel from the operator station.

15. The mobile machine of claim 14, wherein:
the fender frame includes opposing frame members; and
the at least one slat extends in a slat length direction between the opposing frame members a distance about equal to an axial dimension of the front wheel.

16. The mobile machine of claim 15, wherein the at least one slat includes a plurality of slats oriented substantially parallel to each other.

17. The mobile machine of claim 15, wherein;
the opposing frame members and the at least one slat together form a generally box-like first assembly;
the fender frame further includes a generally box-like second assembly; and
first assembly is connected to the second assembly to partially enclose the front wheel.

18. The mobile machine of claim 16, wherein the at least one slat is tilted about a lengthwise edge in a fender length direction of the opposing frame members.

19. The mobile machine of claim 16, wherein the at least one slat is generally perpendicular to a fender length direction of the opposing frame members.

20. The mobile machine of claim 16, wherein the at least one slat is oriented diagonally between the opposing frame members.
